(19) United States
(12) Patent Application Publication
(10) Pub. No.: US 2009/0021479 A1
(43) Pub. Date: Jan. 22, 2009

(54) Device for Extracting Data by Hand Movement

(76) Inventor: Axel Blonski, Heidelberg (DE)

Correspondence Address: Thomas M. Galgano;Galgano & Associates, 20 W. Park Avenue, Suite 204, Long Beach, NY, 11561, US

(21) Appl. No.: 11/664,913

(22) PCT Filed: Oct. 4, 2005
(86) PCT No.: PCT/DE05/01766

§ 371 Date: Apr. 6, 2007

(30) Foreign Application Priority Data
Oct. 6, 2004 (DE) 10 2004 048 655.7
Nov. 18, 2004 (DE) 10 2004 055 726.8

(51) Int. Cl. G09G 5/08

(52) U.S. Cl. 345/158

(57) ABSTRACT

The invention relates to a hand receiver (12) mounted on an x-y-z linear guiding flexion- and torsion-resistant guide extending in a Cartesian coordinate system and consisting of three guiding rails (20, 24, 28) which are pairwisely perpendicular with respect to each other and sliding with respect to each other in the direction of axes x, y and z. Path-signal transmitters detect the translatory movement components of the receiver (12) in the direction of the axes x, y and z of the guiding rails (20, 24, 28).

The invention relates to a device for extracting data by way of hand movement.

Such a device is generally known as a computer mouse. The mouse is operated with a hand. Its displacement movement on a level surface is detected in two dimensions, and converted into data that serve to control the movements of a cursor over the image plane of a monitor. The mouse has buttons for a left and right mouse click, which is performed with the index finger or middle finger. In the case of a so-called scroll mouse, a rotary button is furthermore provided between the buttons.

It is the task of the invention to create a universal interface between a human and an apparatus or system controlled by him/her, which optimally utilizes the dexterity of human hand movements.

The device that accomplishes this task utilizes the movement of a human hand in all three spatial directions in order to extract data. The device has an accommodation for the hand, which is affixed to an x-y-z linear guide that describes a Cartesian coordinate system, is resistant to bending and torsion, and has three guide rails that are orthogonal relative to one another, in pairs, and displaceable relative to one another in the x, y, and z axis direction. The guide rails should have the lowest possible friction in the displacement direction, great bending resistance, and great resistance to twisting. The device is provided with path transducers for the translatory movement components of the accommodation in the x, y, and z axis direction of the guide rails.

Each linear guide rail has, in general, the property of deactivating five degrees of freedom, namely two translatory degrees of freedom and three rotary degrees of freedom, and leaving only one translatory degree of freedom. It is not important for the invention what internal structure of the linear guide rail is used to achieve this; for example, one can think of two parallel guide rods and a runner with a slide or roll guide on it.

Detecting the movement components with an x-y-z linear guide that defines a Cartesian coordinate system optimally utilizes the dexterity of the human hand, and particularly yields data that are easy to process further. It should be noted that trajectories in space can also be represented in other 3D coordinates, for example coordinates based on a non-orthogonal vector triple, cylinder coordinates, sphere coordinates. However, the implementation of these coordinates in a 3D guide is very complicated, for one thing, and for another, because of anisotropic friction behavior, it does not give a good haptic feeling. A triple of vectors whose intermediate angle deviates slightly from 90° defines a Cartesian coordinate system in the sense of the invention.

In a preferred embodiment, the device has sensors for the position of guide rails and runners, which are guided in displaceable manner, one on each guide rail, and in turn each carry and/or displaceably guide a guide rail. Guide rails and runners can be kinematically interchanged.

In a preferred embodiment, a first guide rail is disposed in stationary manner. A first runner is guided displaceably on the first guide rail, and carries a second guide rail that is orthogonal to the first guide rail. A second runner is displaceably guided on the second guide rail, and a third guide rail, orthogonal to the first and second guide rail, is guided displaceably on it. The accommodation for the hand is affixed to the third guide rail.

In the case of an alternative preferred embodiment, a first guide rail is disposed in stationary manner. A first runner is guided displaceably on the first guide rail, and carries a second guide rail that is orthogonal to the first guide rail. A second runner is displaceably guided on the second guide rail, and carries a third guide rail, orthogonal to the first and second guide rail. The accommodation for the hand is displaceably guided on the third guide rail.

In a preferred embodiment, the third guide rail can be rotated about its axis, counter to a re-set moment, and is provided with an angle transducer.

In a preferred embodiment, the runners are driven on the guide rails by motors, or vice versa. Active, location-dependent forces can be exerted by means of the drive motors, for example for purposes of force feedback, for calibration purposes, and others.

In a preferred embodiment, the runners are braked on the guide rails, or vice versa. The braking force is preferably adjustable, specifically as a function of the relative position of the guide rails and runners. In this way, a good sense of control and great positional accuracy are achieved.

In a preferred embodiment, at least one of the guide rails is a round rod.

In a preferred embodiment, the accommodation has a double-T profile having contact regions for the palm and the back of the hand, and having a center crosspiece in between, which comes to lie between two fingers.

In a preferred embodiment, the accommodation has a switch that is activated by means of a vise grip of thumb and index finger of the hand resting in the accommodation, and yields a switching signal. A left mouse click is brought about with this switch.

In a preferred embodiment, the accommodation has a switch that is activated by means of a vise grip of thumb and middle finger of the hand resting in the accommodation, and yields a switching signal. A right mouse click is brought about with this switch.

In a preferred embodiment, the accommodation can rotate and is provided with an angle transducer. The device thereby converts rotations of the hand into data. There are rotary degrees of freedom about an axis in the elbow joint and about two axes in the wrist joint that lie perpendicular to one another.

The signals provided by the path transducers, switches, and angle transducers can be analog or digital, electrical, electronic, opto-electronic, or optical. Signals for digital-electronic control technology and data processing stand in the foreground.

The device has a preferred use for controlling the movements of an object in space that is standing under visual observation. Preferably, the signals of the path transducers for the translatory movement components of the accommodation are utilized for controlling synchronous translatory movements of the object, which movements are at least felt to be essentially parallel visually, on the same axis and in the same direction.

In a preferred embodiment, the path distances of the object movement are proportional to the path distances of the accommodation. The distances that the object travels can be greater than, equal to, or less than the distances that the hand resting in the accommodation travels.

In a preferred embodiment, the object stands under direct visual observation. This variant has applications in handling and machining technology.

In an alternative preferred embodiment, the object stands under microscopic observation. This variant has applications in microsurgery and neurosurgery.

In an alternative preferred embodiment, the object stands under endoscopic observation. This variant has applications in minimally invasive surgery.

Other possible uses of the device lie in an artistic spatial trajectory production, graphological and movement-physiological studies. Last but not least, the device can serve to control a computer, particularly by means of influencing a cursor on the monitor of the latter.

In the following, the invention will be presented in greater detail using an exemplary embodiment shown in the drawing. This shows:

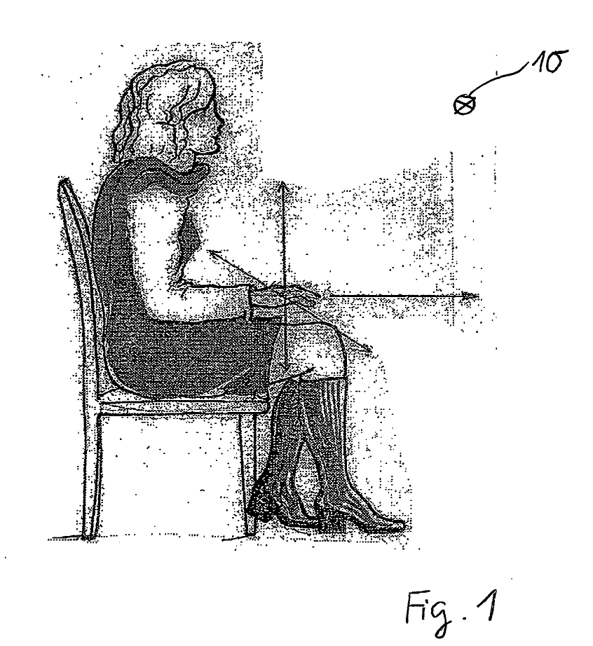

FIG. 1 a person who is controlling the movement of an object she is observing in space, using her hand;

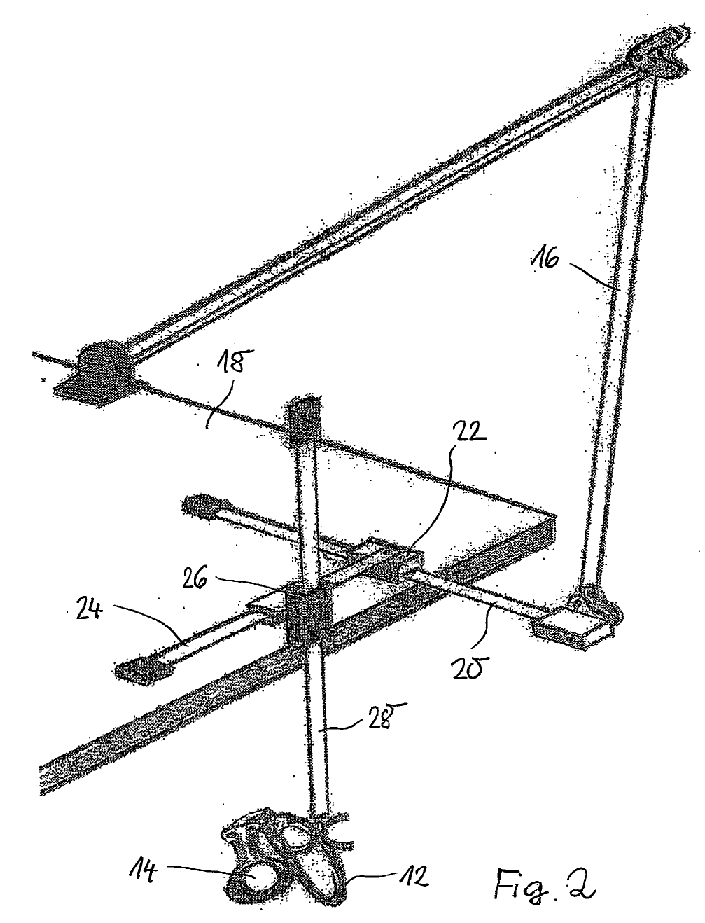

FIG. 2 a perspective view of a device serving for control, with an accommodation for the hand;

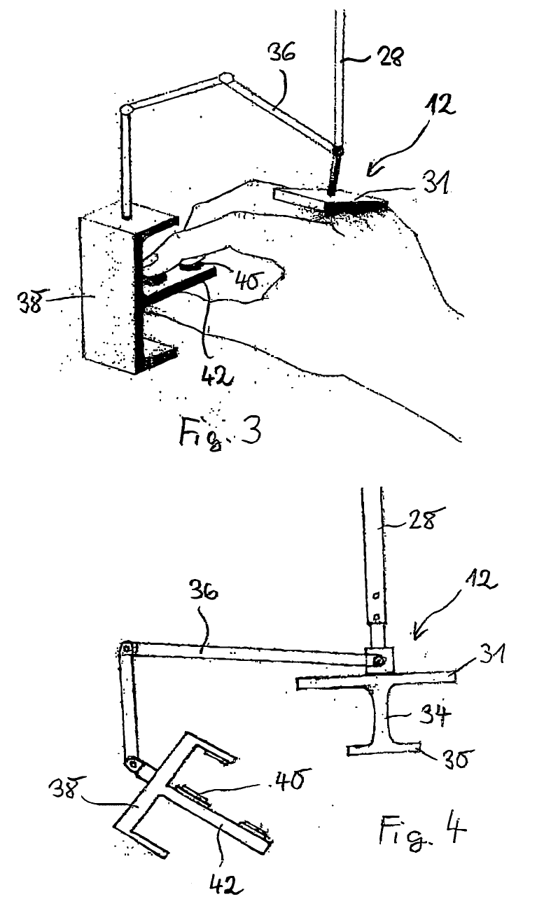

FIG. 3 a perspective view of a modified accommodation;

FIG. 4 a front view of the accommodation according to FIG. 3;

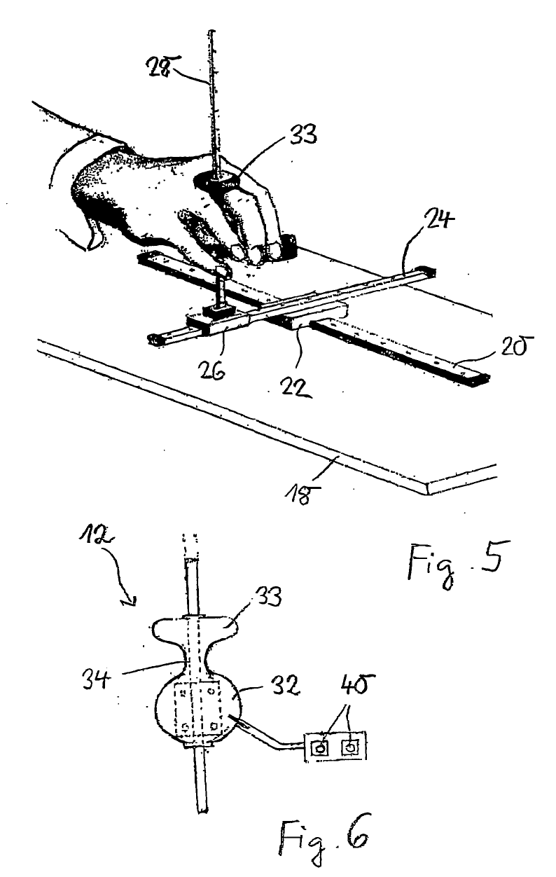

FIG. 5 a perspective view of another accommodation;

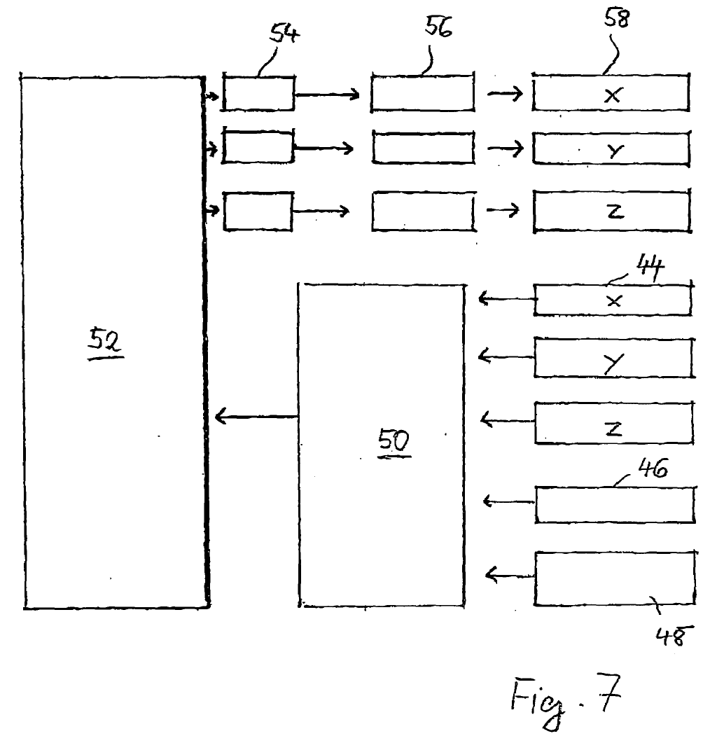

FIG. 6 a front view of the accommodation according to FIG. 5; and

FIG. 7 a block diagram.

In the representation of FIG. 1, the person controlling the movement of an object 10 is right-handed. The person is holding her right arm at an angle, and holding her right hand in the air. The arm position approximately corresponds to that of a piano player.

The person controls the movement of the object 10 she is observing using translatory movements of her hand, which she performs left-right, up-down, forward-back. These movements are converted into movements of the object 10, on the same axis and in the same direction. By means of a vise grip of thumb and index finger, the person performs a left mouse click, and by means of a vise grip of thumb and middle finger, a right mouse click. Furthermore, rotation of the hand is detected and used for controlling the movement of the object 10.

FIG. 2 shows a device that detects the hand movements and converts them into the movements of the object 10. This device has an accommodation 12 with finger openings 14 for the hand controlling the object 10. The accommodation 12 allows room for the fingers to perform vise grips, which bring about the aforementioned mouse clicks.

In the embodiment according to FIG. 3 and FIG. 4, the accommodation 12 has a double-T profile having contact plates 30, 31 for the palm and the back of the hand, and having a center crosspiece 34 in between, which comes to lie between the middle finger and the ring finger. A click button 38 in the form of an E profile having two contacts 40 for index finger and center finger on the top of an extended center shank 42, under which the thumb lies, sits on an articulated rod 36 that extends over the back of the hand.

In the embodiment according to FIG. 5 and FIG. 6, the accommodation 12 has ball-shaped contact bodies 32, 33 for the palm and the back of the hand.

Coming back to FIG. 2, the accommodation 12 is affixed so as to rotate on a Cartesian x-y-z guide, which is mounted on a table top 18 with an angled arm 16. An angle transducer detects rotations of the accommodation 12, which correspond to rotations of the hand.

The z rail 20 of the x-y-z guide is rigidly affixed to the arm 16; it extends forward-back in the horizontal. A runner 22 is affixed to the z rail 20, in longitudinally adjustable manner; it carries the x rail 24 of the x-y-z guide. The x rail 24 extends left-right in the horizontal. A runner 26 is affixed to the x rail 24, in longitudinally adjustable manner; the y rail 28 of the x-y-z guide is guided on it, in longitudinally adjustable manner. The y rail 28 extends in the vertical. The accommodation 12 is affixed at its lower end. The x rail 24 and the z rail 20 are linear guide rails.

In the variant according to FIG. 5, the z rail 20 is directly attached to the top of the table top 18. The runner 26 on the x rail 24 bears the vertical y rail 28. The accommodation 12 is guided on the y rail 28 in longitudinally adjustable manner.

The x-y-z guide has transducers for the position of the rails 20, 24, 28 and runners 22, 26. The sensors can be potentiometric sensors. If the rails 20, 24, 28 and runners 22, 26 are guided on rollers, it is also possible to use angle transducers on the rollers, and, in the case of guidance with a rack and pinion, angle transducers can be used on the gear wheels.

The runners 22, 26 are braked on the rails 20, 24, 28 with an adjustable braking force. An electromagnetic brake serves for this purpose.

As the block diagram FIG. 7 shows, path codings 44 x, y, z, an angle of rotation coding 46, and other data 48, particularly the mouse clicks, are entered into a data protocol 50 as serial codings, and sent to the computer 52. The latter delivers control signals for the brakes 58 x, y, z at analog outputs 54 having power levels 56.

### LIST OF REFERENCE SYMBOLS

10 object
12 accommodation
14 finger opening
16 arm
18 table top
20 z rail
22 runner
24 x rail
26 runner
28 y rail
30 contact plate
31 contact plate
32 contact body
33 contact body
34 center crosspiece
36 articulated rod
38 click button
40 contact
42 center shank
44 path coding
46 angle of rotation coding
48 mouse click
50 data protocol
52 computer
54 analog output
56 power level
58 brake

1. Device for extracting data by way of hand movement in all three spatial directions, having an accommodation for the hand, which is affixed to an x-y-z linear guide that describes a Cartesian coordinate system, is resistant to bending and torsion, and has three guide rails that are orthogonal relative to one another, in pairs, and displaceable relative to one another in the x, y, and z axis direction, and having path transducers for the translatory movement components of the accommodation in the x, y, and z axis direction of the guide rails.

2. Device according to claim 1, wherein it has sensors for the position of guide rails and runners, which are guided in displaceable manner, one on each guide rail, and in turn each carry and/or displaceably guide a guide rail.

3. Device according to claim 2, wherein a first guide rail is disposed in stationary manner, that a first runner (is guided displaceably on the first guide rail, and carries a second guide rail that is orthogonal to the first guide rail, that a second runner is displaceably guided on the second guide rail, and a third guide rail, orthogonal to the first and second guide rail, is guided displaceably on it, and that the accommodation for the hand is affixed to the third guide rail.

4. Device according to claim 2, wherein a first guide rail is disposed in stationary manner, that a first runner is guided displaceably on the first guide rail, and carries a second guide rail that is orthogonal to the first guide rail, that a second runner is displaceably guided on the second guide rail, and carries a third guide rail, orthogonal to the first and second guide rail, and that the accommodation for the hand is displaceably guided on the third guide rail.

5. Device according to claim 3, wherein the third guide rail can be rotated about its axis, counter to a re-set moment, and is provided with an angle transducer.

6. Device according to claim 2, wherein the runners are driven on the guide rails by motors, or vice versa.

7. Device according to claim 2 wherein the runners are braked on the guide rails, or vice versa.

8. Device according to claim 7, wherein the braking force is adjustable, preferably specifically as a function of the relative position of the guide rails and runners.

9. Device according to claim 2, wherein, at least one of the guide rails is a round rod.

10. Device according to claim 1, wherein the accommodation has a double-T profile having contact regions for the palm and the back of the hand, and having a center crosspiece in between, which comes to lie between two fingers.

11. Device according to claim 1, wherein the accommodation has a switch that is activated by means of a vise grip of thumb and index finger of the hand resting in the accommodation, and yields a switching signal.

12. Device according to claim 1, wherein the accommodation has a switch that is activated by means of a vise grip of thumb and middle finger of the hand resting in the accommodation, and yields a switching signal.

13. Device according to claim 1, wherein the accommodation can rotate and is provided with an angle transducer.

14. Device according to claim 1 for controlling the movement of an object in space that is under visual observation.

15. Device according to claim 14, wherein the signals of the path transducers for the translatory movement components of the accommodation are utilized for controlling synchronous translatory movements of the object, which movements are at least felt to be essentially parallel visually, on the same axis and in the same direction.

16. Device according to claim 14, wherein the path distances of the object movement are proportional to the path distances of the accommodation.

17. Device according to claim 14, wherein the object stands under direct visual observation.

18. Device according to claim 14, wherein the object stands under microscopic observation.

19. Device according to claim 14, wherein the object stands under endoscopic observation.

20. Device according to claim 1 for an artistic spatial trajectory production.

21. Device according to claim 1 for graphological studies.

22. Device according to claim 1 for movement-physiological studies.

23. Device according to claim 1 for controlling a computer, particularly by means of influencing a cursor on the monitor of the latter.
